(19) United States
(12) Patent Application Publication
(10) Pub. No.: US 2022/0358620 A1
(43) Pub. Date: Nov. 10, 2022

(54) REMOTE ASSISTANCE SYSTEM AND REMOTE ASSISTANCE METHOD

(71) Applicant: Woven Planet Holdings, Inc., Tokyo (JP)

(72) Inventors: Toshinobu WATANABE, Setagaya-ku (JP); Sho Mikuriya, Yokohama-shi (JP)

(73) Assignee: Woven Planet Holdings, Inc., Tokyo (JP)

(21) Appl. No.: 17/735,626

(22) Filed: May 3, 2022

(30) Foreign Application Priority Data
May 7, 2021 (JP) 2021-079309

(51) Int. Cl. G06T 3/40; G06V 20/58; G06V 10/60; G05D 1/00; G06F 3/04817

(52) U.S. Cl. CPC G06T 3/4038; G06T 3/4053; G06V 20/584; G06V 10/60; G05D 1/0038; G06F 3/04817; G05D 2201/0213

(57) ABSTRACT

A processor of a remote facility executes image generation processing to generate assistance image data to be displayed on a display based on front image data indicating front image data of a vehicle. In the image generation processing, when an image of a traffic light is included in the front image data, it is determined whether recognition likelihood of a luminescent state of a light emitting section of the traffic light is equal to or smaller than a threshold. If it is determined that recognition likelihood is less than or equal to the threshold, super-resolution processing of a preset region including the traffic light in the front image data is executed. Then, super-resolution image data of the preset region by the super-resolution processing is superimposed on a region corresponding to the preset region in the front image data. As such, the assistance image data is generated.

The present application claims priority under 35 U.S.C. § 119 to Japanese Patent Application No. 2021-079309, filed May 7, 2021, the contents of which application are incorporated herein by reference in their entirety.

### TECHNICAL FIELD

The present disclosure relates to a system and a method to remotely assist an operation of a vehicle.

### BACKGROUND

JP2018-77649A disclose a system to perform a remote operation of a vehicle. The system in the prior art includes a management facility on which an operator performing the remote operation resides. The remote operation by the operator is initiated in response to a request from the vehicle. During the remote operation, the vehicle transmits various data to the management facility. The examples of the various data include surrounding environment data of the vehicle acquired by an equipment mounted on the vehicle such as a camera. The examples of the surrounding environment data include image data. The image data is provided to the operator via a display of the management facility.

To secure driving safety of the vehicle during a remote assistance including the remote operation by the operator, it is desirable for the operator to recognize a luminescent state of a light emitting section of a traffic light remote from the vehicle in a high resolution. However, because of a limitation in communication volume from the vehicle, it is expected that a resolution of the image data received by the management facility is not very high. Therefore, even if the management facility receives the image data having a low resolution, a technical development is required to improve the luminescent state of the light emitting section of the traffic light included in this image data to a level at which the operator can recognize.

One object of the present disclosure is to provide a technique capable of improving the luminescent state of the light emitting section of the traffic light included in the image data transmitted from the vehicle to a level at which the operator can recognize in the remote assistance the operation of the vehicle.

### SUMMARY

A first aspect is remote assistance system and has the following features.

The remote assistance system comprises a vehicle and a remote facility configured to assist an operation of the vehicle.

The remote facility includes a memory and a processor. The memory stores front image data indicating image data in front of the vehicle. The processor is configured to execute, based on the front image data, image generation processing to generate assistance image data to be displayed on a display of the remote facility.

In the image generation processing, the processor is configured to:

when a traffic light image is included in the front image data, determine whether or not a recognition likelihood of a luminescent state of a light emitting section of a traffic light is equal to or smaller than a threshold;

if it is determined that the recognition likelihood is equal to or less than the threshold, execute super-resolution processing of a preset region including the traffic light in the front image data; and

generate the assistance image data by superimposing the super-resolution image data of the preset region obtained by the super-resolution processing on a region corresponding to the preset region in the front image data.

A second aspect further has the following features in the first aspect.

The remote facility further comprises a data base in which simulated image data simulating a luminescent state of a light emitting section of a traffic light is stored.

The threshold includes a first threshold corresponding to the threshold and a second threshold lower than the first threshold.

In the image generation processing, the processor is further configured to:

if it is determined that the recognition likelihood is less than or equal to the first threshold, determine whether the recognition likelihood is less than or equal to the second threshold;

if it is determined that the recognition likelihood is less than or equal to the second threshold, generate the assistance image data based on the super-resolution image data;

if it is determined that the recognition likelihood is not less than or equal to the second threshold, refer to the database by using the luminescent state recognized in the front image data and select simulated image data corresponding to the luminescent state; and

generate the assistance image data by superimposing the simulated image data on a region corresponding to the preset region in the front image data.

A third aspect further has the following features in the second aspect.

The remote facility further comprises a data base in which icon data indicating a luminescent state of a light emitting section of a traffic light is stored.

In the image generation processing, the processor is further configured to:

if it is determined that recognition likelihood is not less than or equal to second threshold, refer to the database by using the luminescent state recognized in the front image data and select icon data corresponding to the luminescent state; and

generate the assistance image data by superimposing the icon data in a vicinity of a region on which the simulated image data is superimposed.

A fourth aspect is a remote assistance method of an operation of a vehicle and has the following features.

A processor of a remote facility configured to perform the remote assistance executes image generation processing to generate assistance image data to be displayed on a display of the remote facility based on front image data indicating image data in front of the vehicle.

In the image generation processing, the processor is configured to:

when a traffic light image is included in the front image data, determine whether or not a recognition likelihood of a luminescent state of a light emitting section of a traffic light is equal to or smaller than a threshold;

if it is determined that the recognition likelihood is equal to or less than the threshold, execute super-resolution processing of a preset region including the traffic light in the front image data; and

generate the assistance image data by superimposing the super-resolution image data of the preset region obtained by the super-resolution processing on the preset region in the front image data.

A fifth aspect further has the following features in the fourth aspect.

The threshold includes a first threshold corresponding to the threshold and a second threshold lower than the first threshold.

In the image generation processing, the processor is further configured to:

if it is determined that the recognition likelihood is less than or equal to the first threshold, determine whether the recognition likelihood is less than or equal to the second threshold;

if it is determined that the recognition likelihood is less than or equal to the second threshold, generate the assistance image data based on the super-resolution image data;

if it is determined that the recognition likelihood is not less or equal to than the second threshold, perform a reference to a database in which simulated image data simulating a luminescent state of a light emitting section of a traffic light is stored by using the simulated image data recognized in the front image data, and then select the simulated image data corresponding to the luminescent state; and

generate the assistance image data by superimposing the simulated image data on a region corresponding to the preset region in the front image data.

A sixth aspect further has the following features in the fifth aspect.

In the image generation processing, the processor is further configured to:

if it is determined that the recognition likelihood is less than or equal to the second threshold, perform a reference to a database in which icon data indicating a luminescent state of a light emitting section of a traffic light is stored by using the luminescent state recognized in the front data, and then select icon data corresponding to the luminescent state; and

generate the assistance image data by superimposing the icon data in a vicinity of a region on which the simulated image data is superimposed.

According to the first or fourth aspect, if the recognition likelihood of the luminescent state is equal to or less than the threshold, the assistance image data including the super-resolution image data of the preset region including the traffic light can be displayed on the display. Therefore, even if the recognition likelihood is equal to or less than the threshold, it is possible to improve the luminescent state to a level at which the operator can recognize. Therefore, the driving safety of the vehicle during the remote assistance by the operator can be ensured.

According to the second or fifth aspect, if the recognition likelihood of the luminescent state is equal to or less than the second threshold, the assistance image data including the super-resolution image data of the preset region including the traffic light can be displayed on the display. If the recognition likelihood of the luminescent state is greater than the second threshold and is less than or equal to the first threshold, the assistance image data containing the simulated image data of the preset region including the traffic light can be displayed on the display. The simulated image data is image data simulating the luminescent state. Therefore, it is possible to obtain the same effect as the effect according to the first or fourth aspect.

According to the third or sixth aspect, if the recognition likelihood of the luminescent state is greater than the second threshold and is equal to or less than first threshold value, the icon data can be displayed in the vicinity of the region where the simulated image data is superimposed. The icon data is image data indicating the luminescent state. Therefore, it is possible to increase the effect according to the second or fifth aspect.

### BRIEF DESCRIPTION OF DRAWINGS

FIG. 1 is a conceptual diagram for explaining a remote assistance performed in a remote assistance system according to an embodiment;

FIG. 2 is a schematic diagram illustrating an example of assistance image data displayed on a display;

FIG. 3 is a schematic diagram illustrating an example of assistance image data generated when a recognition likelihood is equal to or less than a threshold;

FIG. 4 is a diagram illustrating an example of a relationship between the recognition likelihood and the assistance image data;

FIG. 5 is a schematic diagram illustrating another example of the assistance image data generated when the recognition likelihood is equal to or less than the threshold;

FIG. 6 is a diagram illustrating another example of the relationship between the recognition likelihood and the assistance image data;

FIG. 7 is a schematic diagram illustrating an example of assistance image data generated when the recognition likelihood is greater than a second threshold and less than or equal to a first threshold;

FIG. 8 is a diagram illustrating a configuration example of a vehicle;

FIG. 9 is a block diagram illustrating a configuration example of a remote facility;

FIG. 10 is a block diagram illustrating a function configuration example of a data processing device of the vehicle;

FIG. 11 is a block diagram illustrating a function configuration example of a data processing device of the remote facility;

FIG. 12 is a flowchart illustrating a flow of image generation processing;

FIG. 13 is a flowchart illustrating a flow of super-resolution processing; and

FIG. 14 is a diagram illustrating an outline of processing in step S172 of FIG. 13.

### DESCRIPTION OF EMBODIMENT

Hereinafter, an embodiment of a remote assistance system and a remote assistance method according to present disclosure will be described reference to the drawings. Note that the remote assistance method according to the embodiment is realized by computer processing executed in the remote assistance system according to the embodiment. In the drawings, the same or corresponding portions are denoted by the same sign, and descriptions to the portions are simplified or omitted.

### 1. Outline of Embodiment

### 1-1. Remote Assistance

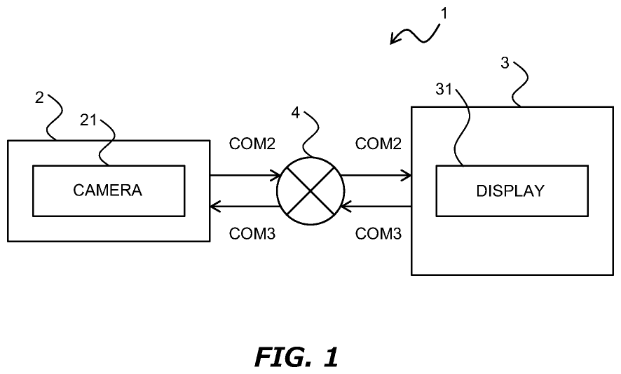

FIG. 1 is a conceptual diagram for explaining a remote assistance performed in a remote assistance system according to the embodiment. A remote assistance system 1 shown in FIG. 1 includes a vehicle 2 which is an object of the remote assistance and a remote facility 3 which communicates with the vehicle 2. The communication between the vehicle 2 and the remote facility 3 is performed via a network 4. In this communication, communication data COM2 is transmitted from the vehicle 2 to the remote assistance device 3. On the other hand, communication data COM3 is transmitted from the remote assistance device 3 to the vehicle 2.

Examples of the vehicle 2 include a vehicle in which an internal combustion engine such as a diesel engine or a gasoline engine is used as a power source, an electronic vehicle in which an electric motor is used as the power source, or a hybrid vehicle including the internal combustion engine and the electric motor. The electric motor is driven by a battery such as a secondary cell, a hydrogen cell, a metallic fuel cell, and an alcohol fuel cell.

The vehicle 2 runs by an operation of a driver of the vehicle 2. The operation of the vehicle 2 may be performed by a control system mounted on the vehicle 2. This control system, for example, supports the running of the vehicle 2 by an operation of the driver, or controls for an automated running of the vehicle 2. If the driver or the control system makes an assistance request to the remote facility 3, the vehicle 2 runs by the operation from an operator residing in the remote facility 3.

The vehicle 2 includes a camera 21. The camera 21 capture an image (a moving image) of surrounding environment of the vehicle 2. The camera 21 includes at least one camera provided for capturing the image at least in front of the vehicle 2. The camera 21 for capturing the front image is, for example, on a back of a windshield of the vehicle 2. The image data acquired by the camera 21 (hereinafter also referred to as “front image data”) IMG is typically moving image data. However, the front image data IMG may be still image data. The front image data IMG is included in the communication data COM2.

When the remote facility 3 receives an assistance requiring signal from a driver or the control system of the vehicle 2, it assists an operation of the vehicle 2 based on an operation of an operator. The remote facility 3 is provided with a display 31. Examples of the display 31 include a liquid crystal display (LCD: Liquid Crystal Display) and an organic EL (OLED: Organic Light Emitting Diode) display.

During an operation assistance by the operator, the remote facility 3 generates “assistance image data AIMG” as data for display on the display 31 based on the front image data IMG received from the vehicle 2. The operator grasps surrounding environment of the vehicle 2 based on the assistance image data AIMG displayed on the display 31 and enters an assistance instruction for the vehicle 2. The remote facility 3 transmits data of the assistance instruction to the vehicle 2. This assistance instruction is included in the communication data COM3.

Examples of the assistance performed by the operator include recognition assistance and judgment assistance. Assume that the control system of the vehicle 2 executes processing to an automated driving. In this case, it may be necessary to assist the automated driving. For example, when a sunlight impinges on a traffic light in front of the vehicle 2, an accuracy of a recognition luminescent state of a light emitting section (e.g., green, yellow, and red light emitting section, and an arrow light emitting section) of the traffic light is degraded. If the luminescent state cannot be recognized by the control system, it is also difficult for the control system to determine what action should be performed at what time. In such cases, the recognition assistance of the luminescent state and/or the judgement assistance in the behavior of the vehicle 2 based on the luminescent state recognized by the operator is performed.

Examples of the assistance performed by the operator also include a remote operation. The remote operation is performed not only when the vehicle 2 is running automatically by the control system of vehicle 2, but also when the vehicle 2 is running by a manipulation of a driver of the vehicle 2. In the remote operation, the operator performs a driving operation of the vehicle 2 including at least one of steering, acceleration, and deceleration with reference to the assistance image data AIMG displayed on the display 31. In this case, the assistance instruction from the operator indicates a content of the driving operation of the vehicle 2. The vehicle 2 performs at least one of the steering, acceleration, and deceleration in accordance with data included in the assistance instruction.

### 1-2. Features of Embodiment

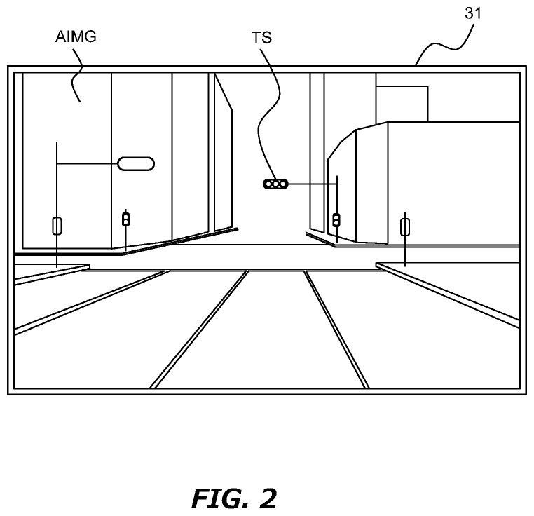

FIG. 2 is a schematic diagram illustrating an example of the assistance image data AMG displayed on the display 31. In the example shown in FIG. 2, the assistance image data AIMG in a vicinity of an intersection generated based on the front image data IMG in front of the vehicle 2 is displayed on the display 31. A traffic light TS directs passages of the vehicle 2 in the intersection. When the assistance of the operation of the vehicle 2 is performed, the operator recognizes a luminescent state of a light emitting section of the traffic light TS included in the assistance image data AIMG and enters the assistance instruction.

Incidentally, to secure a driving safety of the vehicle 2, it is desirable that the luminescent state can be recognized by a high resolution. In particular, when the remote operation is performed, it is desirable that the luminescent state can be recognized by the high resolution even if a distance from the vehicle 2 to the traffic light TS is large. However, there is a limitation in communication volume of the communication data COM2. Therefore, it is expected that the resolution of the front image data IMG received by the remote facility 3 is not so high.

### 1-2-1. First Example

Therefore, in the embodiment, a likelihood LH of the recognition of the luminescent state included in the front image data IMG received from the vehicle 2 is acquired at the generation of the assistance image data AIMG. Here, the recognition likelihood LH is a numerical value that indicates an accuracy of an output of an object detected by using a deep learning. Specific examples of the recognition likelihood LH include an index of a classification result outputted together with the classification result of the object of the deep learning using YOLO (You Only Look Once) network. Note that the method for acquiring the recognition likelihood LH applicable to the embodiment is not particularly limited to the method mentioned above.

If the recognition likelihood LH of the luminescent state (hereinafter also referred to as “recognition likelihood LH_{LMP}”) is low, the operator may not be able to recognize the luminescent state when looking at the front image data IMG (that is, the assistance image data AIMG) displayed on the display 31. Therefore, in the first example of the embodiment, when the recognition likelihood LH_{LMP} is less than or equal to a threshold TH, an image quality of the image data is improved by applying a “super-resolution technique” to the image data of a recognition region including the traffic light TS. The super-resolution technique is a technique for transforming (mapping) an image data of an inputted low resolution to that of a high resolution.

As the super-resolution technique, for example, the technique described in the following document is exemplified. In this document, a SRCNN is disclosed in which deep learning based on a CNN (Convolutional Neural Network) is applied to the super resolution (Super Resolution) A model (hereinafter also referred to as a “super-resolution model”) for transforming the image data of the inputted low resolution into that of the high resolution is obtained by a machine-learning.

Chao Dong, Chen Change Loy, Kaiming He, and Xiaoou Tang, “Image Super-Resolution Using Deep Convolutional Networks”, arXiv:1501.00092v3[cs.CV], Jul. 31, 2015 (https://arxiv.org/pdf/1501.00092.pdf)

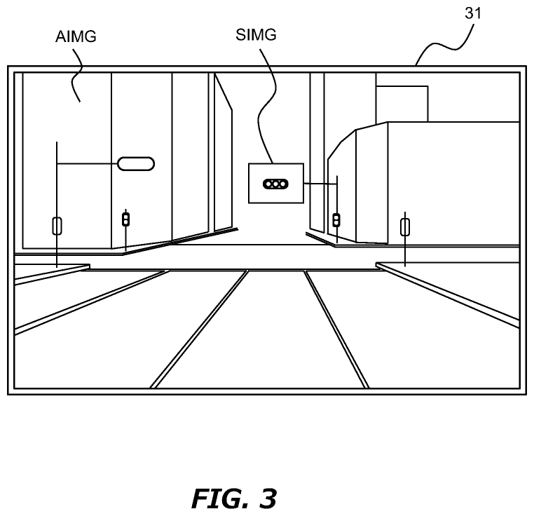

Hereinafter, an image data of a preset region improved by the application of the super-resolution technology is referred to as “super-resolution image data SIMG”. In the embodiment, if the super-resolution image data SIMG is generated, the front image data IMG is synthesized with this super-resolution image data SIMG. FIG. 3 is a schematic diagram illustrating an example of the assistance image data AIMG generated when the recognition likelihood LH_{LMP} is less than or equal to the threshold TH. In the example shown in FIG. 3, the assistance image data AIMG generated by superimposing the super-resolution image data SIMG on the preset region of the front image data IMG is displayed on the display 31.

On the other hand, when the recognition likelihood LH_{LMP} is high, it is presumed that the operator can easily recognize the luminescent state when looking at the front image data IMG (i.e., the assistance image data AIMG) displayed on the display 31. Therefore, in the embodiment, when the recognition likelihood LH_{LMP} is higher than the threshold TH, the application of the super-resolution technique is not performed, and the assistance image data AIMG is generated using the front image data IMG as it is.

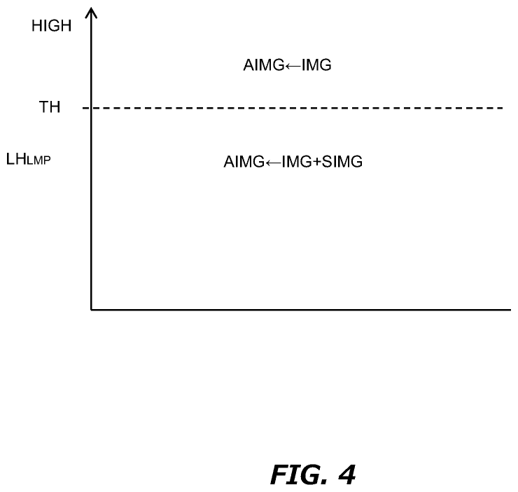

FIG. 4 is a diagram illustrating an example of a relationship between the recognition likelihood LH_{LMP} and the assistance image data AIMG. As shown in FIG. 4, if the recognition likelihood LH_{LMP} is higher than the threshold TH, the assistance image data AIMG is generated based on the front image data IMG. On the other hand, if the recognition likelihood LH_{LMP} is less than or equal to the threshold TH, the assistance image data AIMG is generated based on the front image data IMG and the super-resolution image data SIMG.

### 1-2-2. Second Example

In the second example, when recognition likelihood LH_{LMP} is less than or equal to threshold TH, the generation method of the assistance image data AIMG in the first example is further subdivided. In the second example, a threshold TH and a threshold smaller than this threshold TH are set. For convenience of explanation, the former is referred to as a “first threshold TH1” and the latter is referred to as a “second threshold TH2” (TH1>TH2).

In the second example, if the recognition likelihood LH_{LMP} is greater than the second threshold TH2 and less than or equal to the first threshold TH1, simulated image data QIMG corresponding to the luminescent state is selected. The simulated image data QIMG is image data simulating the luminescent state of the light emitting section. The simulated image data QIMG is data indicating alternative data of an actual luminescent state and is set in advance.

Even if the recognition likelihood LH_{LMP} is equal to or less than the first threshold TH1 value, if the recognition likelihood LH_{LMP} is greater than the second threshold TH2 value, it is estimated that there is a certain accuracy in the classified result of the luminescent state. In the second example, therefore, the selected simulated image data QIMG is combined with the front image data IMG.

When the recognition likelihood LH_{LMP} is less than or equal to the second threshold TH2, the generation method of the assistance image data AIMG is the same as that described in the first example. That is, in this case, the super-resolution image data SIMG is generated. When the selection of the simulated image data QIMG or the generation of the super-resolution image data SIMG is performed, the selected or generated image data is synthesized with the front image data IMG.

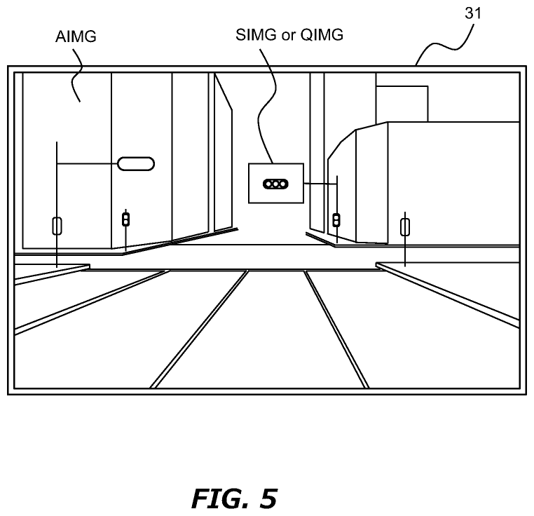

FIG. 5 is a schematic diagram illustrating another example of the assistance image data AIMG generated when the recognition likelihood LH_{LMP} is less than or equal to the threshold TH. In the depicted FIG. 5, the assistance image data AIMG generated by superimposing the super-resolution image data SIMG or the simulated image data QIMG on the preset region of the front image data IMG is displayed on the display 31.

When the recognition likelihood LH_{LMP} is higher than the threshold TH, the generation method of the assistance image data AIMG is the same as that described in first example. That is, the assistance image data AIMG is generated by using the front image data IMG as it is.

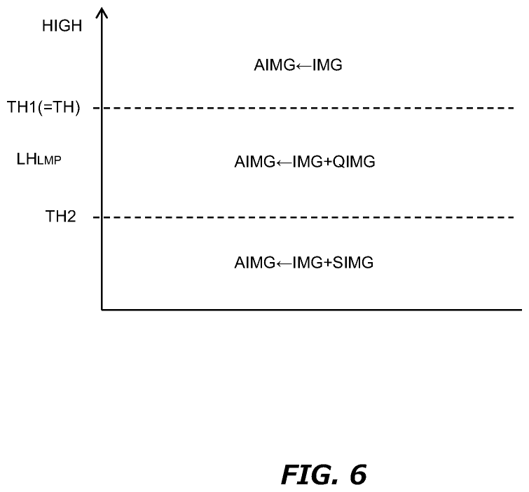

FIG. 6 is a diagram illustrating another illustration of the relationship between the recognition likelihood LH_{LMP} and the assistance image data AIMG. As shown in FIG. 6, if the recognition likelihood LH_{LMP} is higher than the first threshold TH1 (i.e., the threshold TH shown in FIG. 4), the assistance image data AIMG is generated based on the front image data IMG. If the recognition likelihood LH_{LMP} is greater than the second threshold TH2 and less than or equal to the first threshold TH1, the assistance image data AIMG is generated based on the front image data IMG and the simulated image data QIMG. If the recognition likelihood LH_{LMP} is less than or equal to the second threshold TH2, the assistance image data AIMG is generated based on the front image data IMG and the super-resolution image data SIMG.

### 1-2-3. Third Example

In the third example, if the recognition likelihood LH_{LMP} is greater than the second threshold TH2 and less than or equal to the first threshold TH1, icon data ICN corresponding to the luminescent state is selected. As described in the second example, even if the recognition likelihood LH_{LMP} is equal to or less than the first threshold TH1 value, when the recognition likelihood LH_{LMP} is greater than the second threshold TH2 value, it is estimated that there is a certain accuracy in the classified result of the luminescent state. Therefore, in the third example, the icon data ICN is selected as supplement data to the simulated image data QIMG described in the second example. The icon data ICN is data indicating the light emitting section in the luminescent state and is set in advance. For example, when the green light emitting section is in the luminescent state, the icon data indicates “signal: green”.

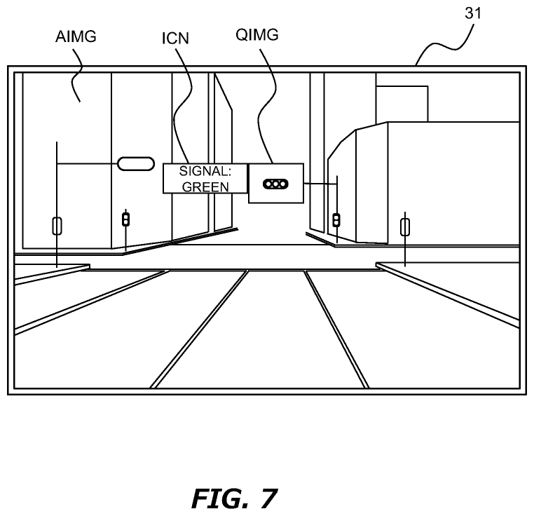

When the selection of the icon data ICN is performed, this icon data ICN is combined with the simulated image data QIMG and the front image data IMG. FIG. 7 is a schematic diagram illustrating an example of the assistance image data AIMG generated when the recognition likelihood LH_{LMP} is greater than or equal to the second threshold TH2 and less than or equal to the first threshold TH1. In the example shown in FIG. 7, the assistance image data AIMG is displayed on the display 31, in which the simulated image data QIMG is superimposed on a preset region of the front image data IMG and the icon data ICN is superimposed in the vicinity of the preset region.

As described above, according to the embodiment, it is possible to display on the display 31 the assistance image data AIMG generated in accordance with the recognition likelihood LH_{LMP}. Therefore, it is possible for the operator to recognize the luminescent state easily not only when the recognition likelihood LH_{LMP} is high but also when the recognition likelihood LH_{LMP} is low. Therefore, the driving safety of the vehicle 2 during the remote assistance by the operator can be ensured.

Hereinafter, the remote assistance system according to the embodiment will be described in detail.

### 2. Remote Assistance System

### 2-1. Configuration Example of the Vehicle

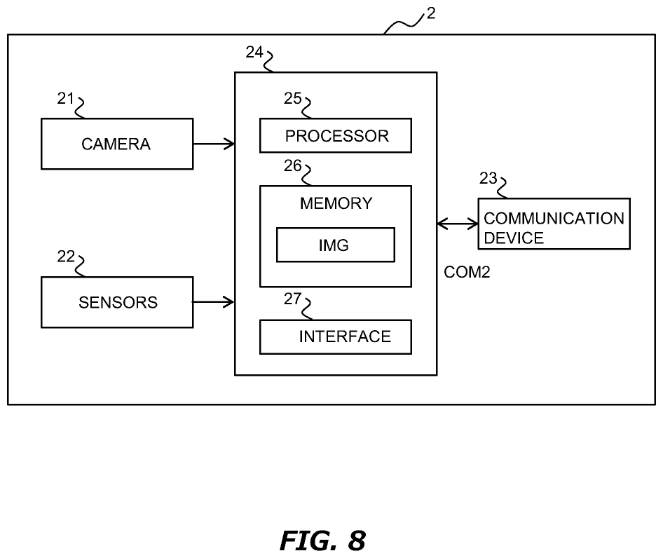

FIG. 8 is a diagram illustrating a configuration example of the vehicle 2 shown in FIG. 1. As shown in FIG. 8, the vehicle 2 comprises the camera 21, sensors 22, a communication device 23, and a data processing device 24. The cameras 21, the sensors 22 and the communication device 23 are connected to the data processing device 24 by, for example, a vehicle-mounted network (i.e., a CAN (Car Area Network)). The description of the camera 21 is as described above in the description of FIG. 1.

The sensors 22 include a condition sensor that detects a status of the vehicle 2. Examples of the condition sensor include a velocity sensor, an acceleration sensor, a yaw rate sensor, and a steering angle sensor. The sensors 22 also include a position sensor that detects a position and an orientation of the vehicle 2. Examples of the position sensor include a GNSS (Global Navigation Satellite System) sensor. The sensors 20 may further include a recognition sensor other than the camera 21. The recognition sensor recognizes (detects) a surrounding environment of the vehicle 2 using radio waves or light. Examples of the recognition sensor include a millimeter wave radar and a LIDAR (Laser Imaging Detection and Ranging).

The communication device 23 wirelessly communicates with a base station of the network 4. Examples of the communication standard of this wireless communication include a mobile communication standard such as 4G, LTE, and 5G. A communication point of the communication device 23 includes the remote facility 3. In the communication with the remote facility 3, the communication device 23 transmits the communication data COM2 that was received from the data processing device 24 to the remote facility 3. In the communication with the remote facility 3, the communication device 23 transmits to the communication data COM2 that was received from the data processing device 24.

The data processing device 24 is a computer for processing various data acquired by the vehicle 2. The data processing device 24 includes a processor 25, a memory 26, and an interface 27. The processor 25 includes a CPU (Central Processing Unit). The memory 26 is a volatile memory, such as a DDR memory, which develops program used by the processor 25 and temporarily stores various data. Various data acquired by vehicle 2 is stored in the memories 26. This various data includes the front image data IMG described above. The interface 27 is an interface with external devices such as the camera 21 and the sensors 22.

The processor 25 encodes the front image data IMG and outputs it to the communication device 23 via the interface 27. During the encoding process, the front image data IMG may be compressed. The encoded front image data IMG is included in the communication data COM2. Note that the encoding process of the front image data IMG may not be executed using the processor 25 and the memory 26. For example, the various processes may be executed by software processing in a GPU (Graphics Processing Unit) or a DSP (Digital Signal Processor), or by hardware processing in a ASIC or a FPGA.

### 2-2. Configuration Example of the Remote Facility

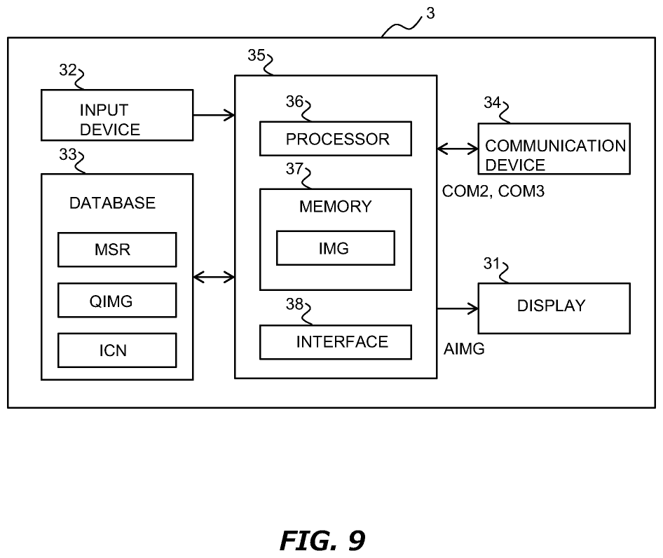

FIG. 9 is a diagram illustrating a configuration example of the remote facility 3 shown in FIG. 1. As shown in FIG. 9, the remote facility 3 includes the display 31, an input device 32, a data base 33, a communication device 34, and a data processing device 35. The input device 32, the data base 33 and the communication device 34 and the data processing device 35 are connected by a dedicated network. The description of the display 31 is as described above in the description of FIG. 1.

The input device 32 is a device operated by the operator of remote facility 3. The input device 32 includes, for example, an input unit for receiving an input from the operator, and a control circuit for generating and outputting the assistance instruction data based on the input. Examples of the input unit include a touch panel, a mouse, a keyboard, a button, and a switch. Examples of the input by the operator include a movement operation of a cursor displayed on the display 31 and a selection operation of a button displayed on the display 31.

When the operator performs the remote operation of the vehicle 2, the input device 32 may be provided with an input device for driving. Examples of the input device for driving include a steering wheel, a shift lever, an accelerator pedal, and a brake pedal.

The data base 33 is a nonvolatile storage medium such as a flash memory or a HDD (Hard Disk Drive). The data base 33 stores various program and various data required for the remote assistance (or the remote operation) of the vehicle 2. Examples of the various data include a super-resolution model MSR. In the embodiment, a plurality of the super-resolution models MSR are prepared in advance in accordance with number of sizes assumed as respective size of a recognition region including the traffic light TS.

The reason why the multiple super-resolution models MSR are prepared is as follows. That is, when the traffic light TS is detected by applying the deep learning (e.g., the deep learning using YOLO network described above) to the front image data IMG, the image data of the recognition region including the traffic light TS is outputted. However, the size of this image data is optional. On the other hand, in the deep learning for the super-resolution (e.g., the SRCNN described above), it is needed to input an image data whose size is fixed. Therefore, when the former aspect ratio differs from the latter aspect ratio, the super-resolution image data is distorted.

The various data stored in the data base 33 include the simulated image data QIMG. The various data may further include the simulated image data QIMG. In the example shown in FIG. 9, the simulated image data QIMG and the icon data ICN are stored in the data base 33. The simulated image data QIMG and the icon data ICN are prepared in accordance with the number of the luminescent state that is estimated in advance. Similar to the super-resolution models MSR, a plurality of the simulated image data QIMG and icon data ICN having different sizes may be prepared in accordance with the number of sizes of the regions including the traffic light TS outputted from the deep learning.

The communication device 34 wirelessly communicates with a base station of the network 4. Examples of the communication standard of this wireless communication include a mobile communication standard such as 4G, LTE, and 5G. A communication partner of the communication device 34 includes the vehicle 2. In the communication with the vehicle 2, the communication device 34 transmits the communication data COM3 that was received from the data processing device 35 to the vehicle 2.

The data processing device 35 is a computer for processing various data. The data processing device 35 includes at least a processor 36, a memory 37, and an interface 38. The processor 36 includes a CPU. The memory 37 develops program used by the processor 36 and temporarily stores various data. The signals inputted from the input device 32 and various data acquired by the remote facility 3 are stored in the memory 37. This various data include the front image data IMG contained in the communication data COM2. The interface 38 is an interface with external devices such as the input device 32, the databases 33, and the like.

The processor 36 executes “image generation processing” in which the front image data IMG is decoded and the assistance image data AIMG is generated. If the front image data IMG is compressed, the front image data IMG is decompressed during the decoding process. The processor 36 also outputs the generated assistance image data AIMG to the display 31 via the interface 38.

The decoding process of the front image data IMG, the image generation processing, and the output process of the assistance image data AIMG described above may not be executed using the processor 36, the memory 37, and the database 33. For example, the various processes described above may be executed by software processing in GPU or DSP, or by hardware processing in ASIC or FPGA.

### 2-3. Function Configuration Example of the Data Processing Device of the Vehicle

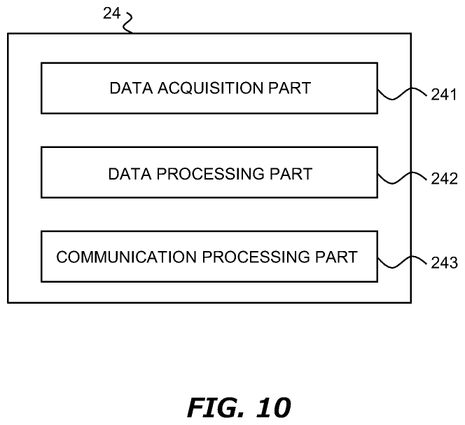

FIG. 10 is a block diagram illustrating a function configuration example of the data processing device 24 shown in FIG. 8. As shown in FIG. 10, the data processing device 24 includes a data acquisition part 241, a data processing unit 242, and a communication processing part 243.

The data acquisition part 241 acquires surrounding environment data, driving state data and location data of the vehicle 2. Examples of the surrounding environment data include the front image data IMG. Examples of the driving state data include driving speed data, acceleration data, yaw rate data, and steering angle data of the vehicle 2. Each of the driving state data is measured by the sensors 22. The location data is measured by the GNSS sensor.

The data processing part 242 processes various data acquired by the data acquisition part 241. Examples of the process of the various data include the encoding process of the front image data IMG.

The communication processing part 243 transmits the front image data IMG (i.e., the communication data COM2) encoded by the data processing part 242 to the remote facility 3 (the communication device 34) via the communication device 23.

### 2-4. Function Configuration Example of the Data Processing Device of the Remote Facility

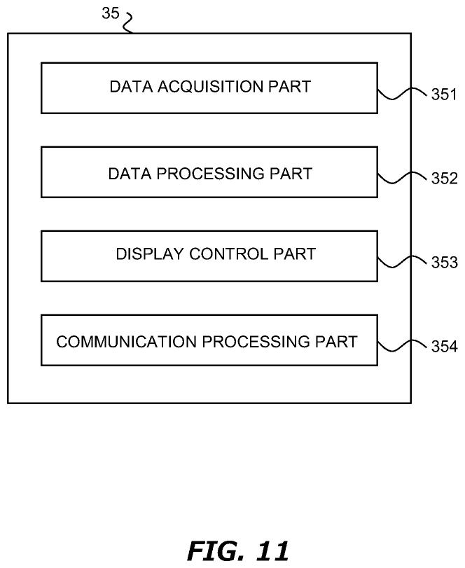

FIG. 11 a block diagram illustrating a function configuration example of the data processing device 35 shown in FIG. 9. As shown in FIG. 11, the data processing device 35 includes a data acquisition part 351, a data processing part 352, a display control part 353, and a communication processing part 354.

The data acquisition part 351 acquires input signals from the input device 32 and the communication data COM2 from the vehicle 2.

The data processing part 352 processes various data acquired by the data acquisition part 351. Examples of the processing of the various data include processing to encode the assistance instruction data. The encoded assistance instruction is included in the communication data COM3. Examples of the process of the various data include decoding process of the front image data IMG, the image generation processing, and outputting process of the assistance image data AIMG. Details of the image generation processing will be described later.

The display control part 353 controls a display content of the display 31 provided to the operator. The control of this display is based on the assistance image data AIMG. The display control part 353 also controls the displayed content based on an input signal acquired by the data acquisition part 351. In the control of the display content based on the input signal, for example, the display content is enlarged or reduced based on the input signal or switching of the display content (transition) is performed. In another example, the cursor displayed on the display 31 is moved or a button displayed on the display 31 is selected based on the input signal.

The communication processing part 354 transmits the assistance instruction data (i.e., the communication data COM3) encoded by the data processing part 352 to the vehicle 2 (the communication device 23) via the communication device 34.

### 2-5. Example of Image Generation Processing

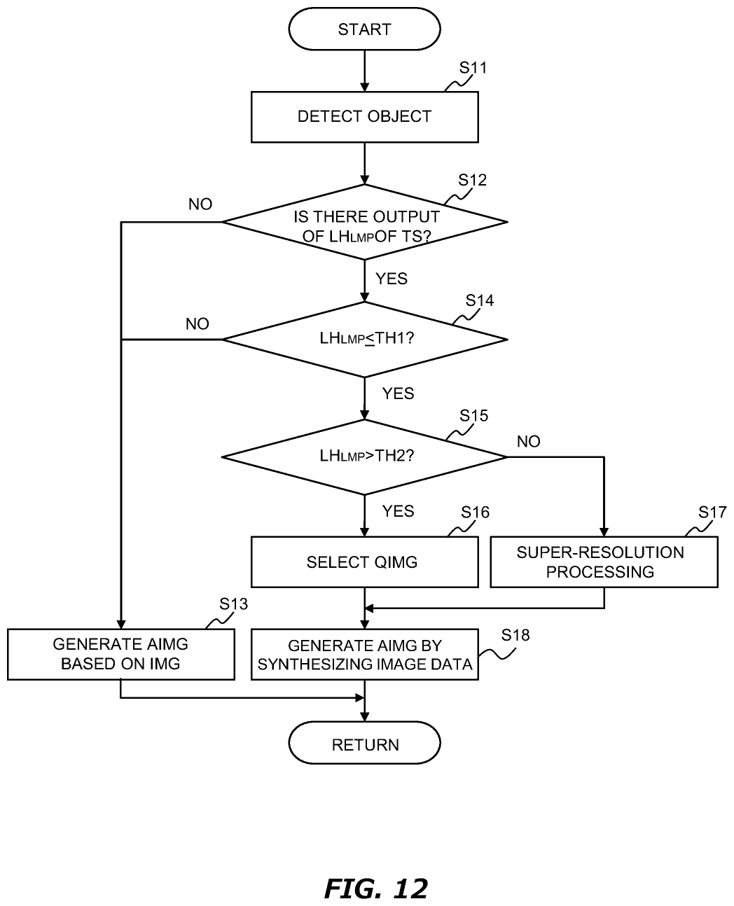

FIG. 12 is a flowchart illustrating a flow of the image generation processing executed by the data processing device 35 (the processor 36) shown in FIG. 9. The routine shown in FIG. 12 is repeatedly executed at a predetermined control cycle when, for example, the processor 36 receives the assist requiring signal to the remote facility 3. Note that the assist requiring signal is included in the communication data COM2.

In the routine shown in FIG. 12, first, an object is detected (step S11). The object is detected by applying a deep learning to the encoded front image data IMG. Examples of the deep learning include the deep learning using the YOLO network described above. According to the deep learning using the YOLO network, an object included in the front image data IMG is detected and the recognition likelihood LH of the detected object is obtained.

After the processing of the step S11, it is determined whether there is an output of the recognition likelihood LH_{LMP} of the traffic light TS (step S12). As described above, the recognition likelihood LH_{LMP} includes the recognition likelihood LH of the luminescent state. Therefore, if the judgement result in the step S12 is negative, it is presumed that the front image data IMG does not include the image of the traffic light TS. Therefore, in this case, the generation of the assistance image data AIMG based on the front image data IMG is executed (step S13).

If the judgement result in the step S12 is positive, it is determined whether the recognition likelihood LH_{LMP} is less than or equal to the first threshold TH1 (step S14). If the judgement result in the step S14 is negative, it is presumed that the operator can easily recognize the luminescent state when looking at the front image data IMG (i.e., the assistance image data AIMG) displayed on the display 31. Therefore, in this case, the processing of the step S13 is executed.

If the judgement result in the step S14 is positive, there is a possibility that the operator may not be able to recognize the luminescent state when looking at the front image data IMG (i.e., the assistance image data AIMG) displayed on the display 31. Therefore, in this case, it is determined whether the recognition likelihood LH_{LMP} is greater than the second threshold TH2 (step S15). The magnitude relation between the first threshold TH1 and the second threshold TH2 is as described above (TH1>TH2).

If the judgement result in the step S15 is positive, it is estimated that there is a certain accuracy in the classified result of the luminescent state detected in the processing of the step S11. Therefore, in this case, the selection of the simulated image data QIMG is performed (step S16). Specifically, the selection of the simulated image data QIMG is performed by referencing the data base 33 by using the luminescent state detected in the processing of the step S11.

In another embodiment of the step S16, the simulated image data QIMG and the icon data ICN are selected. The selection method of the icon data ICN is similar to that of the simulated image data QIMG. That is, the icon data ICN is selected by referring to the data base 33 by using the luminescent state detected in the processing of the step S11.

If the judgement result in the step S15 is negative, the super-resolution processing is executed (step S17). Note that the processing of the steps S15 and S16 may be skipped. That is, when the judgement result in the step S14 is positive, the processing of the step S17 may be executed without executing the processing of the steps S15 and S16. The series of the processing in this case is processing corresponding to the example described in FIGS. 3 and 4.

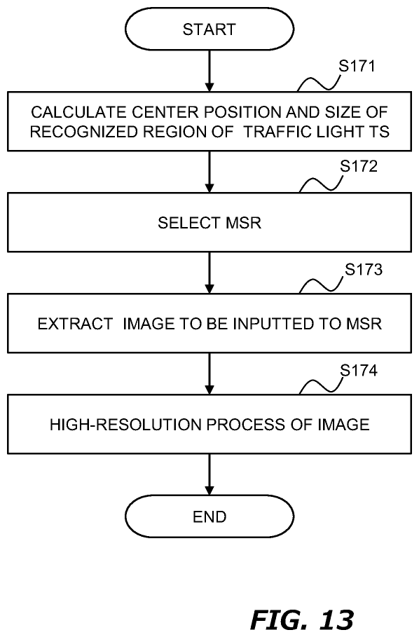

Here, the super-resolution processing will be described by referring to FIG. 13. FIG. 13 is a flowchart illustrating a flow of the super-resolution processing shown in the step S17 of FIG. 12.

In the routines shown in FIG. 13, first, a center position and a size of a recognized region of the traffic light TS are calculated (step S171). As described above, in the processing of the step S11 of FIG. 12, the traffic light TS included in the front image data IMG is detected as the object. When the traffic light TS is detected, the image data of the recognized region including this traffic light TS is outputted. In the processing of the step S171, a coordinate of the center position of the image is calculated, and the size of the image is calculated.

After the processing of the step S171, the super-resolution model MSR is selected (step S172). In the processing of this step S172, a reference is made to the database 33 by using the image size of the recognized region calculated in the processing of the step S171. Then, the super-resolution model MSR having a size close to the image size and having inputs whose length in vertical and transverse direction is longer than the image size is selected.

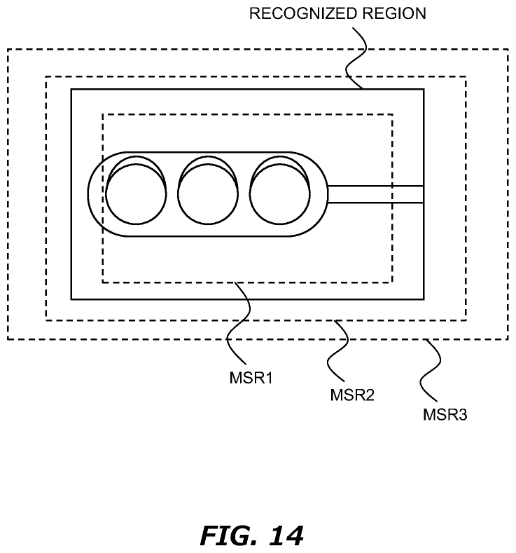

FIG. 14 is a diagram illustrating an outline of the processing in the step S172. As described above, in the embodiment, multiple super-resolution models MSR are prepared in advance in accordance with number of the sizes assumed as respective size of the recognition region including the traffic light TS. The super-resolution models MSR1, MSR2 and MSR3 shown in FIG. 14 are examples of the super-resolution models MSR. In the processing of the step S172, the super-resolution model MSR2 satisfying the size condition described above is selected.

After the processing of the step S172, image data to be inputted to the super-resolution model MSR is extracted (steps S173). In the processing of this step S173, an image having the size matching the input of the super-resolution model MSR that was selected in the step S172 (i.e., the super-resolution model MSR2 in the example shown in FIG. 14) is extracted from the front image data IMG. Specifically, the image is extracted by cutting out a region centered on the coordinate of the center position calculated in the step S171 by a size corresponding to the input of the super-resolution model MSR.

After the processing of the step S173, a high-resolution process of the image is performed (step S174). In the processing of the step S174, the image data extracted in the processing of the step S173 is input to the super-resolution model MSR selected in the processing of the step S172 (i.e., the super-resolution model MSR2 in the example shown in FIG. 14).

Return to FIG. 12 and continue explaining the flow of the image generation processing. After the processing of the step S16 or S17, the assistance image data AIMG is generated by synthesizing the image data (step S18). For example, when the simulated image data QIMG is selected in the step S16, the assistance image data AIMG is generated by combining the simulated image data QIMG and the front image data IMG. When the simulated image data QIMG and the icon data ICN are selected in the step S16, the assistance image data AIMG is generated by combining them with the front image data IMG. When the super-resolution image data SIMG is generated in the step S17, the assistance image data AIMG is generated by combining this super-resolution image data SIMG and the front image data IMG.

When synthesizing the image data, the simulated image data QIMG or the super-resolution image data SIMG is superimposed on a region corresponding to the position of the region of the image extracted in the processing of the step S173 of FIG. 14. When the simulated image data QIMG and the icon data ICN are selected, the icon data ICN is superimposed in the vicinity of the region on which the simulated image data QIMG is superimposed.

### 3. Effect

According to the embodiment described above, it is possible to display on the display 31 the assistance image data AIMG generated in accordance with the recognition likelihood LH_{LMP}. In particular, if the recognition likelihood LH_{LMP} is less than or equal to the first threshold TH1, at least the super-resolution image data SIMG is displayed on the display 31. Therefore, not only when the recognition likelihood LH_{LMP} is high, but also when the recognition likelihood LH_{LMP} is low, the luminescent state can be recognized by the operator. Therefore, the driving safety of the vehicle 2 during the remote assistance by the operator can be ensured.

Further, according to the embodiment, it is possible to display on the display 31 the super-resolution image data SIMG when the recognition likelihood LH_{LMP} is less than or equal to the second threshold TH2, whereas it is possible to display on the display 31 the simulated image data QIMG additionally when the recognition likelihood LH_{LMP} is greater than or equal to the second threshold TH2 and less than or equal to the first threshold TH1. Therefore, even in this case, the luminescent state can be recognized at a higher level.

In addition, according to the embodiment, it is possible to display on the display 31 the simulated image data QIMG and the icon data ICN when the recognition likelihood LH_{LMP} is greater than the second threshold TH2 and is less than or equal to the first threshold TH1. Therefore, by displaying a combination of the two kinds of data, it is possible to increase the recognition level of the luminescent state.

What is claimed is:

1. A remote assistance system, comprising:
a vehicle; and
a remote facility including a memory in which front image data indicating image data in front of the vehicle is stored, and a processor configured to execute, based on the front image data, image generation processing to generate assistance image data to be displayed on a display of the remote facility,
wherein, in the image generation processing, the processor is configured to:
when a traffic light image is included in the front image data, determine whether or not a recognition likelihood of a luminescent state of a light emitting section of a traffic light is equal to or smaller than a threshold;
if it is determined that the recognition likelihood is equal to or less than the threshold, execute super-resolution processing of a preset region including the traffic light in the front image data; and
generate the assistance image data by superimposing the super-resolution image data of the preset region obtained by the super-resolution processing on a region corresponding to the preset region in the front image data.

2. The remote assistance system according to claim 1,
wherein remote facility further includes a data base in which simulated image data simulating a luminescent state of a light emitting section of a traffic light is stored,
wherein the threshold includes a first threshold corresponding to the threshold and a second threshold lower than the first threshold,
wherein, in the image generation processing, the processor is further configured to:
if it is determined that the recognition likelihood is less than or equal to the first threshold, determine whether the recognition likelihood is less than or equal to the second threshold;
if it is determined that the recognition likelihood is less than or equal to the second threshold, generate the assistance image data based on the super-resolution image data;
if it is determined that the recognition likelihood is not less than or equal to the second threshold, refer to the database by using the luminescent state recognized in the front image data and select simulated image data corresponding to the luminescent state; and
generate the assistance image data by superimposing the simulated image data on a region corresponding to the preset region in the front image data.

3. The remote assistance system according to claim 2,
wherein the remote facility further includes a data base in which icon data indicating a luminescent state of a light emitting section of a traffic light is stored,
wherein, in the image generation processing, the processor is further configured to:
if it is determined that recognition likelihood is not less than or equal to second threshold, refer to the database by using the luminescent state recognized in the front image data and select icon data corresponding to the luminescent state; and
generate the assistance image data by superimposing the icon data in a vicinity of a region on which the simulated image data is superimposed.

4. A remote assistance method of an operation of a vehicle,
wherein a processor of a remote facility configured to perform the remote assistance executes image generation processing to generate assistance image data to be displayed on a display of the remote facility based on front image data indicating image data in front of the vehicle,
wherein, in the image generation processing, the processor is configured to:
when a traffic light image is included in the front image data, determine whether or not a recognition likelihood of a luminescent state of a light emitting section of a traffic light is equal to or smaller than a threshold;
if it is determined that the recognition likelihood is equal to or less than the threshold, execute super-resolution processing of a preset region including the traffic light in the front image data; and
generate the assistance image data by superimposing the super-resolution image data of the preset region obtained by the super-resolution processing on the preset region in the front image data.

5. The remote assistance method according to claim 4,
wherein, the threshold includes a first threshold corresponding to the threshold and a second threshold lower than the first threshold,
wherein, in the image generation processing, the processor is further configured to:
if it is determined that the recognition likelihood is less than or equal to the first threshold, determine whether the recognition likelihood is less than or equal to the second threshold;
if it is determined that the recognition likelihood is less than or equal to the second threshold, generate the assistance image data based on the super-resolution image data;
if it is determined that the recognition likelihood is not less or equal to than the second threshold, perform a reference to a database in which simulated image data simulating a luminescent state of a light emitting section of a traffic light is stored by using the simulated image data recognized in the front image data, and then select the simulated image data corresponding to the luminescent state; and
generate the assistance image data by superimposing the simulated image data on a region corresponding to the preset region in the front image data.

6. The remote assistance method according to claim 5,
wherein, in the image generation processing, the processor is further configured to:
if it is determined that the recognition likelihood is less than or equal to the second threshold, perform a reference to a database in which icon data indicating a luminescent state of a light emitting section of a traffic light is stored by using the luminescent state recognized in the front data, and then select icon data corresponding to the luminescent state; and
generate the assistance image data by superimposing the icon data in a vicinity of a region on which the simulated image data is superimposed.
